(19) United States
(12) Patent Application Publication
(10) Pub. No.: US 2018/0204134 A1
(43) Pub. Date: Jul. 19, 2018

(54) EXPERT-AUGMENTED MACHINE LEARNING FOR CONDITION MONITORING

(71) Applicant: HONEYWELL INTERNATIONAL INC., Morris Plains, NJ (US)

(72) Inventor: GREG STEWART, NORTH VANCOUVER (CA)

(21) Appl. No.: 15/410,339

(22) Filed: Jan. 19, 2017

(51) Int. Cl. G06N 99/00; G06N 5/04

(52) U.S. Cl. CPC G06N 99/005; G06N 5/046

(57) ABSTRACT

A method of assisted machine learning for condition monitoring for process equipment or process health includes providing a subject matter expert (SME) assisted monitoring rule generation algorithm for generating mathematical monitoring rules. The algorithm implements receiving SME rating instructions whether to include or ignore each of a plurality of time-series data samples which include at least one process parameter in a pattern, a time stamp and the process equipment the data is sensed from and the equipment's location in the process to provide SME selected time-series data samples, and an initial first rule precursor. Rule results are generated from running the initial first rule precursor on the data samples. Rule results are compared to the SME rating instructions to provide an agreement or disagreement finding. At least once a received change from the SME is implemented which modifies the initial first rule precursor to generate a first mathematical monitoring rule.

### FIELD

Disclosed embodiments relate to rule-based condition monitoring systems for automatic and continuous monitoring of plant equipment and process health.

### BACKGROUND

Processing facilities are often managed using process control systems. Example processing facilities include manufacturing plants, chemical plants, crude oil refineries, and ore processing plants. Among other operations, process control systems typically manage the use of motors, valves, and other industrial equipment in the processing facilities. Processing facilities generally include a control room that has individuals who monitor process data generated and intervene when deemed necessary responsive to process changes.

Some of the process data is in the form of time series data that spans a period of time. Human experts are inherently good at looking at patterns in time series data and being able to point out which if any portions of a given signal (or combination of signals) are potentially valuable from an equipment or process monitoring point of view. A pattern can be 1 signal coming from a sensor as a function of time, but is typically 2 or more sensor signals. For example, a pattern X seen one day may indicate an event of interest, such as low or high efficiency process operations, worst case pending breakdown (being an equipment outage where the process or machine shuts down), while another pattern Y seen another day may be insignificant. These opinions regarding the time series data are usually implicitly based on the experience of a domain expert generally referred to as a Subject Matter Expert.

There are some challenges to data analytics. These challenges include quickly and easily finding examples of similar patterns (generally stored in a data historian, but can also be stored in other file types such as EXCEL, or as comma-separated values (CSV) to a current pattern of interest to compare and contrast, annotating and recording those patterns one wishes to identify) for use in monitoring and those patterns one wishes to ignore. A mathematical rule is then generated that delivers a sufficiently high rate of true positives (correctly predicting when a given condition or equipment breakdown may occur) along with a sufficiently low rate of false positives (incorrectly predicting when a given condition or equipment breakdown may occur).

One commercially available rule-based condition monitoring system is Honeywell's UNIFORMANCE® ASSET SENTINEL which continuously monitors equipment and process health. The ASSET SENTINEL includes a process and equipment monitoring module that monitors process performance and equipment health to minimize unplanned losses and maximize uptime, and a smart instrument monitoring module that continuously assesses the health and performance of smart instruments, helping users to minimize unplanned downtime and maximize investments in smart instrumentation. The ASSET SENTINEL has a Calculation Engine to perform simple-to-complex statistical calculations and data manipulation, and Event Detection and Notification for situations requiring the earliest possible attention and follow-up. The ASSET SENTINEL's event detection environment makes it possible for new user-defined mathematical rules to be implemented and used to trigger alerts and warnings.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize although standard rule-based condition monitoring tools are helpful industrial tools for the monitoring of plant equipment and process health, the requirement for the user to manually generate all new mathematical rules slows the adding of such rules, and can lead to new rules not having a sufficiently high rate of true positives and a sufficiently low rate of false positives to be useful. Disclosed embodiments include machine assisted learning and rule generation for condition monitoring for process equipment or health of a process that at least partially automates the generation of new mathematical rules for the condition monitoring.

One disclosed embodiment comprises a method of assisted machine learning for condition monitoring for process equipment or process health that includes providing a Subject Matter Expert (SME) assisted monitoring rule generation algorithm for generating a plurality of mathematical monitoring rules including a first mathematical monitoring rule. The rule generation algorithm implements (i) receiving from the SME rating instructions whether to include or ignore each of a plurality of time-series data samples that include at least one process parameter in a pattern, a time stamp, and the process equipment the time-series data is sensed from and the equipment's location in the process, and (ii) an initial first rule precursor. Rule results are generated from running the initial first rule precursor on the time-series data samples. Rule results are compared to the SME rating instructions to provide an agreement finding or a disagreement finding. At least once a received change from the SME is implemented which modifies the initial first rule precursor to generate the first mathematical monitoring rule.

### BRIEF DESCRIPTION OF THE DRAWINGS

FIG. 1A is a flow chart for steps in an example method of assisted machine learning for condition monitoring, according to an example embodiment.

FIG. 1B shows an example workflow presented in an algorithmic presentation which largely corresponds to the steps in the method shown in FIG. 1A.

FIG. 2A shows the placement of a disclosed condition monitoring system in a plant control system having multiple network levels.

FIG. 2B shows blocks making up an example workflow in which a disclosed condition monitoring system is embedded within, according to an example embodiment.

FIGS. 3A and 3B show an example work flow including a SME working with a disclosed condition monitoring system.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

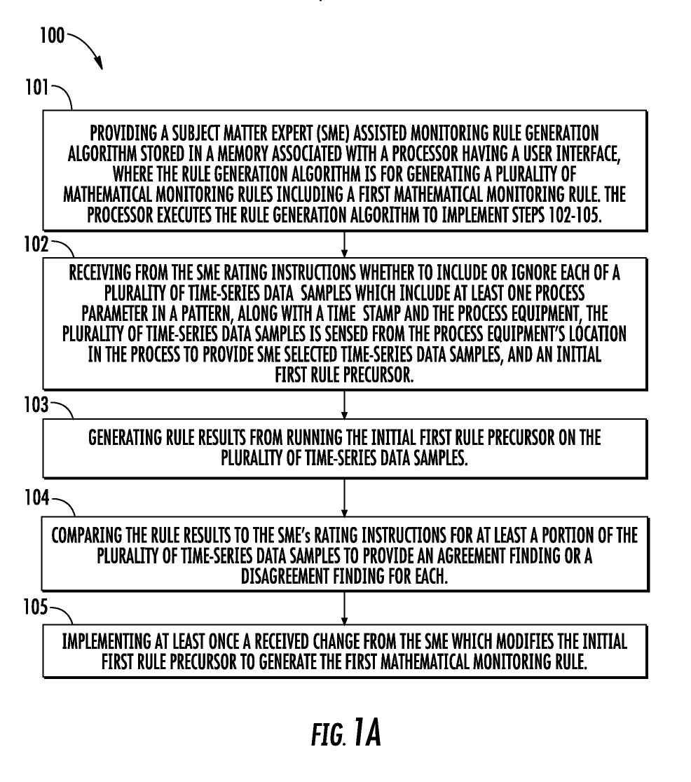

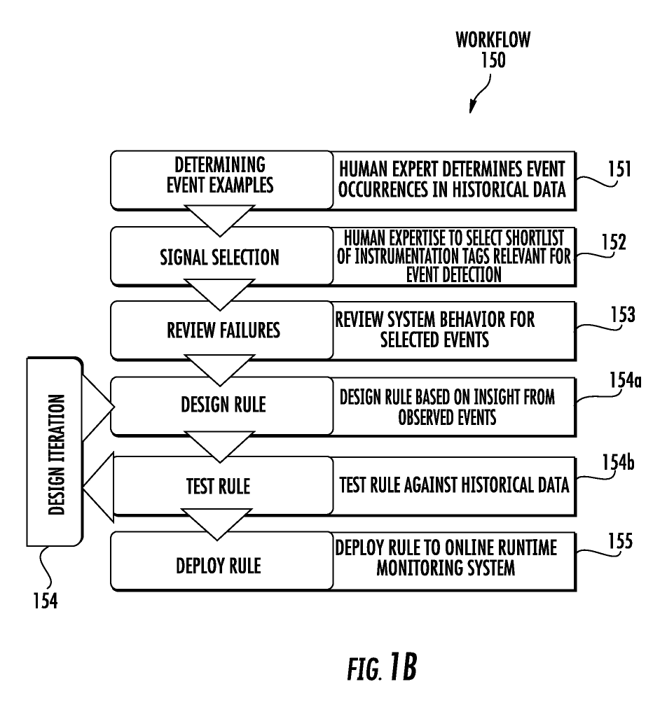

FIG. 1A is a flow chart for steps in an example method 100 of machine assisted learning and rule generation for condition monitoring for process equipment or the health of a process involving a tangible material, according to an example embodiment. Method 100 generally involves a SME working with a disclosed condition monitoring system. Step 101 comprises providing an SME assisted monitoring rule generation algorithm stored in a memory associated with a processor having a user interface, where the monitoring rule generation algorithm is for generating a plurality of mathematical monitoring rules including a first mathematical monitoring rule. The processor can comprise a microprocessor, digital signal processor (DSP), or a microcontroller unit (MCU). The processor executes the rule generation algorithm to implement steps 102-105 described below.

Step 102 comprises receiving (i) from the SME rating instructions whether to include or ignore each of a plurality of time-series data samples to provide SME selected time-series data samples, and (ii) an initial first rule precursor. The time-series data samples include at least one process parameter in a pattern, along with a time stamp, and the process equipment the time-series data is sensed from and the equipment's location in the process which may be known via the SME's knowledge, tag name or position in the data historian database hierarchy.

The term “location” as used herein generally thus refers to information that allows a user to know where and what a given sensor is reading. The sensor data is generally stored in a data historian, and it is needed to know where in the process and the equipment any given piece of sensor data is obtained from. For example, if one has temperature sensor data, in order for it to be useful for making predictions one needs to know if the sensor data is attached to compressor X on platform Y, or if the sensor data is attached to heat exchanger J in site K. This information is usually found in the naming convention of the data or may more generally be found in a map of the data to the location in the plant.

Regarding the initial first rule precursor, the initial first rule precursor can be manually generated by the SME or by another individual, or can be generated automatically by an algorithmic approach (e.g. using machine learning approaches such as found in Python or R, etc.). Alternatively, the initial first rule precursor can be hybrid generated by the SME or another individual together with a data science toolbox.

The time-series data samples are generally obtained from a search query within a specified time period from a library of time-series data samples stored in a database (e.g., a data historian). The SME's rating instructions are generally obtained from the SME's pattern analysis by considering occurrences happening both before and after each data sample.

Step 103 comprises generating rule results from running (i.e., testing) the initial first rule precursor on the plurality of time-series data samples. Step 104 comprises comparing the rule results to the SME rating instructions for at least a portion of the time-series data samples to provide an agreement finding or a disagreement finding. The comparing can be performed by an individual or automatically by the rule generation algorithm.

Step 105 comprises implementing at least once a received change from the SME which modifies the initial first rule precursor to generate the first mathematical monitoring rule. The implementing of the change typically beneficially results in improving the true positive (correctly predicting when a given condition or breakdown may occur) rate and/or decreasing the false positive (incorrectly predicting when a given condition or breakdown may occur) rate.

FIG. 1B shows an example workflow 150 presented in an algorithmic presentation which largely corresponds to the steps in method 100 shown in FIG. 1A. Step 151 comprises determining event examples. A human expert (e.g., SME) determines event occurrences from a stored data database (such as in a data historian). Time-series data sample outputs are thus obtained from the database (e.g., a data historian) responsive to a user's query. For example, the time-series data can be obtained responsive to a query having 2 parameters (e.g., temperature and load) over some time period for a given piece of process equipment (e.g., a particular compressor, say compressor 7).

Step 152 comprises signal selection. Human expertise is generally used to select a shortlist of instrumentation sensor signals (typically stored in a data historian and named via “tags”) relevant for event detection. Step 153 comprises the user reviewing failures. System behavior is reviewed for the selected events, such as to review other events that happened before and after this particular time series data combination of interest.

Step 154 comprises test design iteration step that represents the user' expertise in iterating the rule design for tuning the rule based on the user's expertise of what is a true event. The user iterates between designing the rule shown as step 154a that is based on user' expertise/insight from the observed events, and then testing the rule (against historical data) shown as step 154b to determine whether the events are true positive or false positives. The step 154 design iteration 154a, 154b, 154a, 154b . . . generally continues until a desired balance (e.g., a predetermined percentage) of true positive vs. false positives is obtained. Step 155 comprises deploying rule to an online runtime monitoring system (e.g. SENTINEL or other monitoring system).

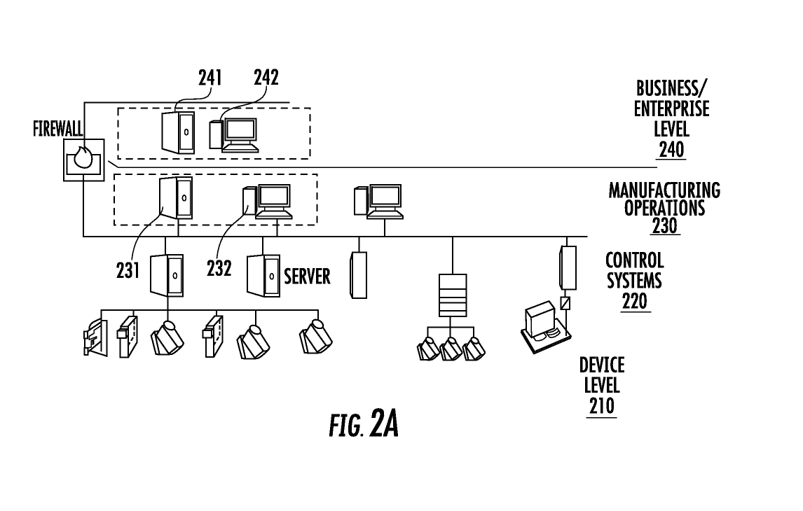

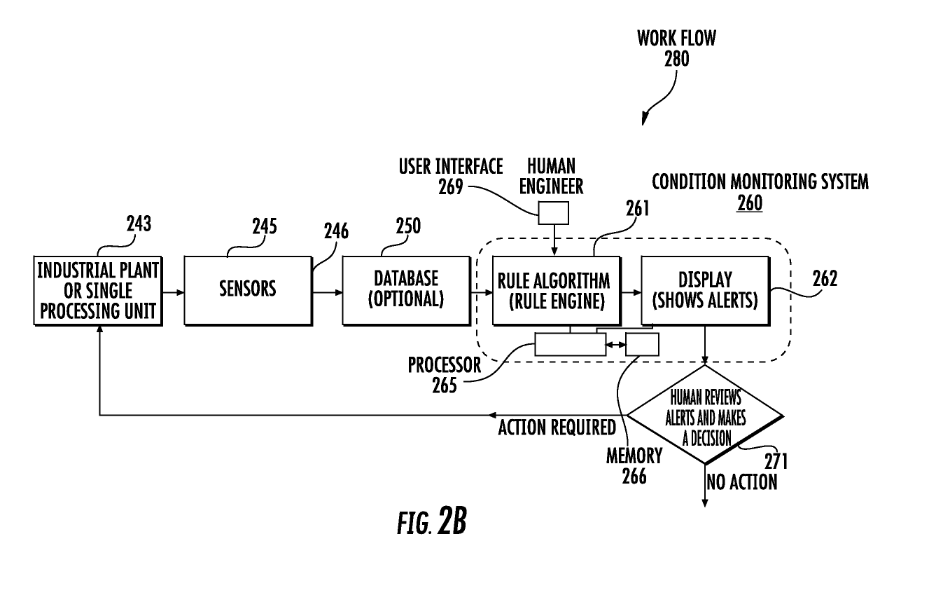

FIG. 2A shows placement of disclosed condition monitoring sentinel in a plant control system having multiple network levels that may include HART compliant devices. The levels shown include a device level 210 that has processing equipment and field devices including sensors and actuators, a control system level 220 including process controller(s), a manufacturing operations level 230, and a business/enterprise level 240. There is shown an asset condition monitoring server 231 implementing a disclosed monitoring rule generation algorithm and client computer 232 in the manufacturing operations level 230, and an asset condition monitoring shadow server 241 implementing a disclosed monitoring rule generation algorithm and client computer 242 in the business/enterprise level 240.

FIG. 2B shows blocks comprising an example workflow 280 in which a disclosed condition monitoring system 260 is embedded within. The condition monitoring system 260 comprises a computing system including a processor 265 having a SME assisted monitoring rule generation algorithm stored in a memory 266 associated with the processor which is shown as a rule algorithm (rule engine) 261, and there is a user interface 269 shown receiving initial monitoring rules from a human engineer (e.g., a SME). The user interface 269 can be wired or a wireless interface. The rule algorithm 261 is for generating a plurality of mathematical monitoring rules including a first mathematical monitoring rule.

An industrial plant or a single processing equipment unit (in the industrial plant) is shown as 243. Sensors 245 are located with respect to processing equipment in the industrial plant 243 to sense process data 246 that is time stamped, is optionally stored in a database 250 (e.g., data historian), which is provided to the rule algorithm 261. The condition monitoring system 260 includes a display 262 that shows alerts generated by the rule algorithm 261 shown as a “rules engine”, such as blinking light alerts. In the decision box shown as 271, a human (e.g., SME) reviews the alerts shown on the display 262 and makes a decision responsive to each alert. As shown in FIG. 2B the decision rendered can be to take no action, or to take some corrective or preventative action in the industrial plant 243, such as performing maintenance on the equipment or ordering spares.

Disclosed embodiments can be applied to generally a wide variety of industrial plants. For example, Disclosed embodiments can be applied to processing facilities including manufacturing plants, chemical plants, crude oil refineries, and ore processing plants.

### EXAMPLES

Disclosed embodiments are further illustrated by the following specific Examples, which should not be construed as limiting the scope or content of this Disclosure in any way.

Some example time-series data sample outputs are first obtained from a database (e.g., a data historian) responsive to a user's query. For example, a user' query may search for all examples where an outage and work order were not preceded by an alert for a particular processing equipment of interest (e.g. compressor #7). This information is used by the SME to decide if a new monitoring rule is indeed needed to add an alert to try to in the future avoid such outages. A query may for example be used to find all time-series data sample examples stored in the database where an event of interest happened on compressor #7 between a particular specified date range. The patterns associated with each of time-domain search result can be combined into a combined visualization with the x-axis being the time (date) of each piece of data and the y-axis being the value of the corresponding sensor signals.

This visualization involves a technology to search for similar signals in time series data (the time-series data samples), such as using a commercially available search technology. Optionally, there is provided the ability to include annotations (e.g., descriptive text, what was found to be problem and the solution used), the display being a function of what time-series data is able to be integrated and linked. It is generally sufficient to link via a time stamp and equipment (or location).

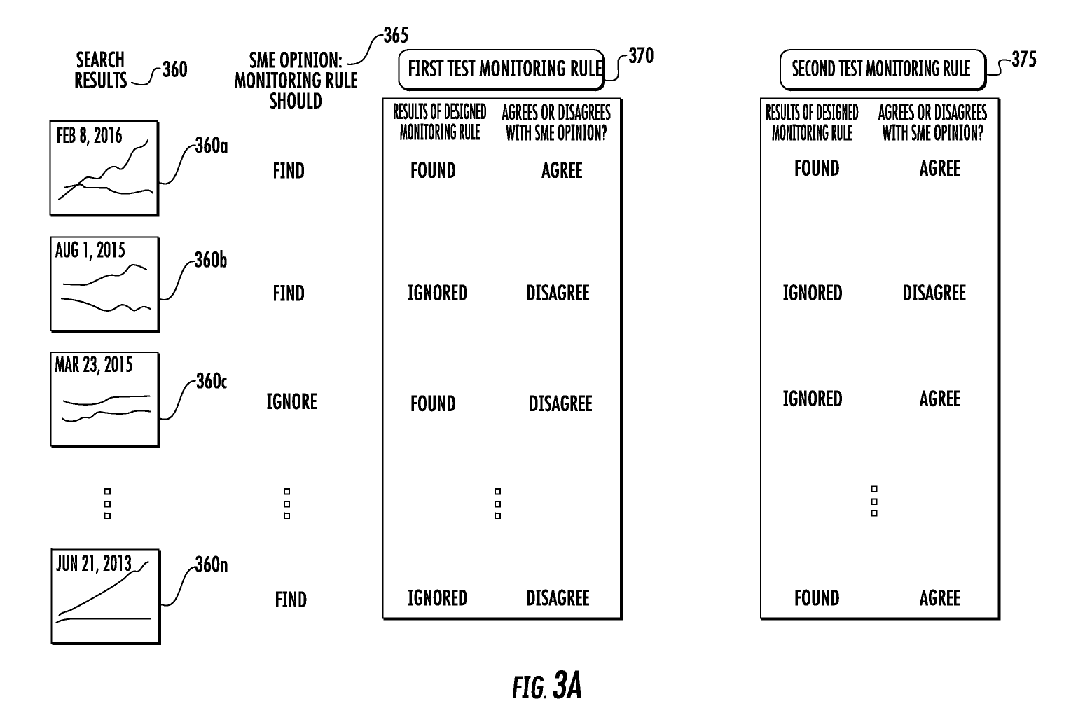

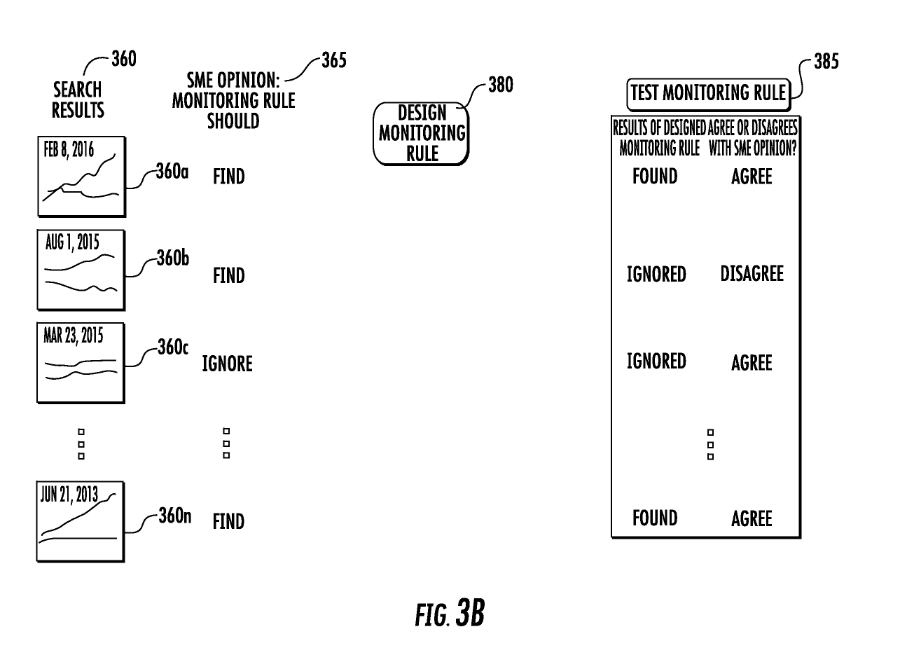

FIG. 3A shows an example SME assisted portion for disclosed partially automated generation of new mathematical rules for condition monitoring. The time-series data search results 360 comprising 360a, 360b, 360c . . . 360n are shown as well as an SME opinion 365 whether the monitoring rule should find or ignore each of the time-series data samples. The SME may grade each of these time-series data sample based on his or her experience and knowledge of events that happened before and after (e.g., informed by a combined visualization) along with an SME' opinion for each time-series data sample. In a first test monitoring rule 370, results of a designed monitoring rule is shown along with an agree or disagree with respect to the SME's opinion for each time-series data sample. The SME mostly disagrees, and the SME will generally make an entry in the condition monitoring system to modify that rule and rerun the test. After the SME revises the monitoring rule (e.g., using a user interface), second test monitoring rule 375 results are shown where the results from the revised monitoring rule is compared to the SME' opinion for each time-series data that is shown improving the agreement rate. These design-test-grade iterations are repeated until the SME achieves a desirable performance from the condition monitoring rule.

FIG. 3B shows an example automated initial rule design for disclosed partially automated generation of new mathematical rules for condition monitoring. The time-series data search results 360 and SME opinion 365 described above are again shown in FIG. 3B. An automatic design monitoring rule design block is shown as design monitoring rule block 380 which may be triggered by a user using a button on the condition monitoring system. The design monitoring rule block 380 includes a classifier that may be designed with training data, where features are comprised of search results and the outcome data grades that were created by the SME. The time series features may generally be encoded in a representation that simplifies the high dimensionality of time series, while sufficient fidelity is provided to provide separation in the outcome data (e.g. simplify using SAX (Symbolic Aggregate approXimation) or wavelets). An initial monitoring rule can then be encoded by the design monitoring rule block 380 from the results (e.g. a kernel for convolution with real time data).

The monitoring rule may then be tested using the same functionality as the expert assisted rule design described relative to FIG. 3A. In the test monitoring rule results box 385 are results of the designed monitoring rule as well as whether each result agrees or disagrees with the SME opinion. As good agreement is shown, no further rule changes are deemed needed, and the monitoring rule may be implemented in the condition monitoring system. The test monitoring rule results may be rendered automatically and the rule after testing implemented automatically, such as on the basis of a predetermined minimum agreement percentage.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

1. A method of assisted machine learning for a condition monitoring system for process equipment or health of a process, comprising:
providing a subject matter expert (SME) assisted monitoring rule generation algorithm stored in a memory associated with a processor having a user interface, said rule generation algorithm for generating a plurality of mathematical monitoring rules including a first mathematical monitoring rule, wherein said processor executes said rule generation algorithm to implement:
receiving from said SME rating instructions whether to include or ignore each of a plurality of time-series data samples which include at least one process parameter in a pattern, along with a time stamp and said process equipment said plurality of time-series data samples is sensed from and said process equipment's location in said process to provide SME selected time-series data samples, and an initial first rule precursor;
generating rule results from running said initial first rule precursor on said plurality of time-series data samples;
comparing said rule results to said SME's rating instructions for at least a portion of said plurality of time-series data samples to provide an agreement finding or a disagreement finding, and
implementing at least once a received change from said SME which modifies said initial first rule precursor to generate said first mathematical monitoring rule.

2. The method of claim 1, wherein said initial first rule precursor is generated by said SME or by another individual.

3. The method of claim 2, wherein said initial first rule precursor is generated automatically by an algorithmic approach, or is hybrid generated by said SME or said another individual together with said algorithmic approach.

4. The method of claim 1, wherein said implementing is manually performed by said SME.

5. The method of claim 1, wherein said implementing is automatically performed by said condition monitoring system.

6. The method of claim 1, wherein said process equipment comprises industrial equipment configured together that is controlled by at least one automatic control system.

7. The method of claim 1, further comprising implementing said first mathematical monitoring rule in said condition monitoring system associated with a plant that includes said process equipment.

8. A condition monitoring system including assisted machine learning for condition monitoring for process equipment or health of a process, comprising:
a computing system including a processor having a subject matter expert (SME) assisted monitoring rule generation algorithm stored in a memory associated with said processor and a user interface, said rule generation algorithm for generating a plurality of mathematical monitoring rules including a first mathematical monitoring rule, wherein said processor executes said rule generation algorithm to implement:
receiving from said SME rating instructions whether to include or ignore each of a plurality of time-series data samples which include at least one process parameter in a pattern, along with a time stamp and said process equipment said plurality of time-series data samples is sensed from and said process equipment's location in said process to provide SME selected time-series data samples, and an initial first rule precursor;
generating rule results from running said initial first rule precursor on said plurality of time-series data samples;
comparing said rule results to said SME's rating instructions for at least a portion of said plurality of time-series data samples to provide an agreement finding or a disagreement finding, and
implementing at least once a received change from said SME which modifies said initial first rule precursor to generate said first mathematical monitoring rule.

9. The system of claim 8, wherein said initial first rule precursor is generated by said SME or by another individual.

10. The system of claim 9, wherein said initial first rule precursor is generated automatically by an algorithmic approach, or is hybrid generated by said SME or said another individual together with said algorithmic approach.

11. The system of claim 8, wherein said implementing is automatically performed by said condition monitoring system.

12. The system of claim 8, wherein said implementing is automatically performed by said rule generation algorithm.

13. The system of claim 8, wherein said process equipment comprises industrial equipment configured together that is controlled by at least one automatic control system.
